(19) United States
(12) Patent Application Publication
(10) Pub. No.: US 2026/0271109 A1
(43) Pub. Date: Sep. 10, 2026

(54) COMMUNICATION METHOD, USER EQUIPMENT, AND NETWORK NODE

(71) Applicant: KYOCERA Corporation, Kyoto (JP)

(72) Inventors: Masato FUJISHIRO, Yokohama-shi, Kanagawa (JP); Henry CHANG, San Diego, CA (US)

(73) Assignee: KYOCERA Corporation, Kyoto (JP)

(21) Appl. No.: 19/659,578

(22) Filed: Apr. 27, 2026

Related U.S. Application Data
(63) Continuation of application No. PCT/JP2024/038575, filed on Oct. 29, 2024.
(60) Provisional application No. 63/594,302, filed on Oct. 30, 2023.

(51) Int. Cl. H04W 76/15; H04W 74/0833

(52) U.S. Cl. CPC H04W 76/15; H04W 74/0833

(57) ABSTRACT

A communication method according to a first aspect of the present disclosure is a communication method performed by a relay node in a cellular communication system, the communication method including the steps of: transmitting, to a donor node, a message including information for determining one of a mobile relay node configuration or a stationary relay node configuration as a configuration of the relay node; and receiving, from the donor node, configuration information indicating configuration content of the relay node.

### RELATED APPLICATIONS

The present application is a continuation based on PCT Application No. PCT/JP2024/038575, filed on Oct. 29, 2024, which claims the benefit of U.S. Provisional Patent Application No. 63/594,302 filed on Oct. 30, 2023. The content of which is incorporated by reference herein in their entirety.

### TECHNICAL FIELD

The present disclosure relates to a communication method, a user equipment, and a network node used in a cellular communication system.

### BACKGROUND

In the Third Generation Partnership Project (3GPP) (trade name, the same applies hereinafter) that is a standardization project for cellular communication systems, a relay node called an Integrated Access and Backhaul (IAB) node is introduced (see Non-Patent Document 1, for example). Specifically, one or more relay nodes are involved in communication between a base station and a user equipment and perform relay operation for the communication.

### CITATION LIST

### Non-Patent Literature

Non-Patent Document 1: 3GPP TS 38.300 V17.6.0 (2023-09)

### SUMMARY

The present disclosure relates to a technique for enabling a relay node to operate according to an appropriate configuration of a mobile relay node configuration and a stationary relay node configuration in a cellular communication system in which a functionality of a mobile relay node is introduced.

In a first aspect of the present disclosure, a communication method is a communication method performed by a relay node in a cellular communication system, the communication method including transmitting, to a donor node, an RRC Setup Complete message including one of a first indication indicating that the relay node connects as a mobile relay node or a second indication indicating that the relay node connects as a stationary relay node.

In a second aspect of the present disclosure, a communication method is a communication method performed by a network node in a cellular communication system, the communication method including the steps of: receiving, from a relay node, an RRC Setup Complete message including one of a first indication indicating that the relay node connects as a mobile relay node or a second indication indicating that the relay node connects as a stationary relay node; and establishing a connection to the relay node based on one of the first indication or the second indication.

In a third aspect of the present disclosure, a relay node is a relay node used in a cellular communication system, the relay node including a transmitter configured to transmit, to the donor node, an RRC Setup Complete message including one of a first indication indicating that the relay node connects as a mobile relay node or a second indication indicating that the relay node connects as a stationary relay node.

In a fourth aspect of the present disclosure, a network node is a network node used as a donor node in a cellular communication system, the network node including: a receiver configured to receive, from a relay node, an RRC Setup Complete message including one of a first indication indicating that the relay node connects as a mobile relay node or a second indication indicating that the relay node connects as a stationary relay node; and a controller configured to establish a connection to the relay node based on one of the first indication or the second indication.

In a fifth aspect of the present disclosure, a communication method is a communication method performed by a relay node in a cellular communication system, the communication method including the steps of: identifying whether the relay node is configured as a mobile relay node by a network; and controlling an operation of the relay node based on whether the relay node is configured as a mobile relay node and a moving state of the relay node.

In a sixth aspect of the present disclosure, a relay node is a relay node used in a cellular communication system, the relay node including a controller configured to identify whether the relay node is configured as a mobile relay node by a network. The controller controls an operation of the relay node based on whether the relay node is configured as a mobile relay node and a moving state of the relay node.

In a seventh aspect of the present disclosure, a network node is a network node used as a donor node in a cellular communication system, the network node including a transmitter configured to transmit, to the relay node, a radio resource control (RRC) message including information for specifying whether to configure a relay node as a mobile relay node.

### BRIEF DESCRIPTION OF THE DRAWINGS

FIG. 1 is a diagram illustrating a configuration example of a cellular communication system according to an embodiment.

FIG. 2 is a diagram illustrating an example of a relationship between an IAB node, parent nodes, and child nodes.

FIG. 3 is a diagram illustrating a configuration example of a gNB being a network node according to the embodiment.

FIG. 4 is a diagram illustrating a configuration example of the IAB node being a relay node according to the embodiment.

FIG. 5 is a diagram illustrating a configuration example of a UE being a user equipment according to the embodiment.

FIG. 6 is a diagram illustrating an example of a protocol stack relating to RRC connection and NAS connection of IAB-MT.

FIG. 7 is a diagram illustrating a protocol stack relating to an F1-U protocol.

FIG. 8 is a diagram illustrating a protocol stack relating to an F1-C protocol.

FIG. 9 is a diagram illustrating an example of an application scenario of a mobile IAB node according to the embodiment.

FIG. 10 is a diagram illustrating an operation overview of a cellular communication system according to a first embodiment.

FIG. 11 is a flowchart illustrating an example of an operation of the IAB node in a first operation pattern according to the first embodiment.

FIG. 12 is a flowchart illustrating an example of an operation of the IAB node in a second operation pattern according to the first embodiment.

FIG. 13 is a diagram for describing Msg5 (RRC Setup Complete message) in the second operation pattern according to the first embodiment.

FIG. 14 is a flowchart illustrating an example of an operation of the IAB node in a third operation pattern according to the first embodiment.

FIG. 15 is a flowchart illustrating an example of an operation of the IAB node in a fourth operation pattern according to the first embodiment.

FIG. 16 is a flowchart illustrating an operation overview of an IAB node according to a second embodiment.

FIG. 17 is a flowchart illustrating an example of an operation of an IAB node in a first operation pattern according to the second embodiment.

FIG. 18 is a flowchart illustrating an example of an operation of the IAB node in the second operation pattern according to the second embodiment.

### DESCRIPTION OF EMBODIMENTS

A cellular communication system according to embodiments will be described with reference to the drawings.

### (1) First Embodiment

A first embodiment will be described. In the description of the drawings, the same or similar parts are denoted by the same or similar reference signs.

### (1.1) System Configuration

A configuration example of a cellular communication system according to an embodiment will be described. A cellular communication system 1 according to the embodiment is a 3GPP 5G system. Specifically, a radio access scheme in the cellular communication system 1 is a New Radio (NR) being a 5G radio access scheme. Note that Long Term Evolution (LTE) may be at least partially applied to the cellular communication system 1. The cellular communication system 1 may also be applied to a future cellular communication system such as 6G.

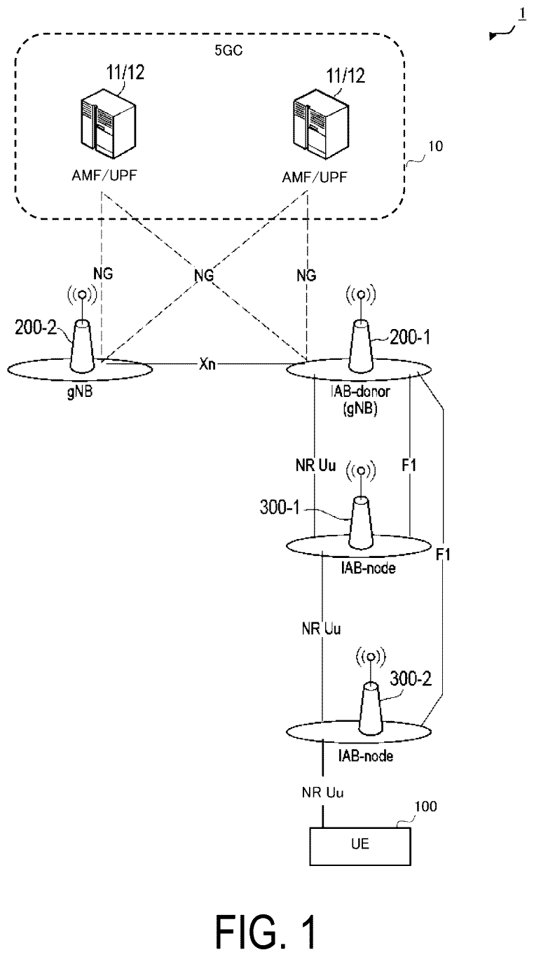

FIG. 1 is a diagram illustrating a configuration example of the cellular communication system 1 according to the embodiment. The cellular communication system 1 includes a 5G core network (5GC) 10, a user equipment (UE) 100, base station apparatuses (hereinafter may be referred to as “base stations”) 200-1 and 200-2, and IAB nodes 300-1 and 300-2. A base station 200 may be referred to as a gNB.

In the following, an example in which the base station 200 is an NR base station will be mainly described, but the base station 200 may also be an LTE base station (that is, an eNB). In the following, the base stations 200-1 and 200-2 may be referred to as the gNBs 200 (or base station 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is an apparatus that performs various mobility control for the UE 100. The AMF 11 communicates with the UE 100 using Non-Access Stratum (NAS) signaling to manage information on an area in which the UE 100 exists. The UPF 12 is an apparatus that performs transfer control of user data, and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, a cell and a base station may be used without distinction. Each gNB 200 is interconnected with the 5GC 10 via an interface referred to as an NG interface. FIG. 1 illustrates the two gNB 200-1 and gNB 200-2, connected to the 5GC 10. Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. A donor gNB 200-1 (or a donor node, hereinafter sometimes referred to as a “donor node”) is a donor base station that is a terminal node of the NR backhaul on the network side and includes additional functionality for supporting the IAB. The backhaul is capable of multi-hopping via a plurality of hops (that is, a plurality of IAB nodes 300). FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a wireless communication apparatus that is movable and performs wireless communication with a cell. The UE 100 may be any apparatus that performs wireless communication with the gNB 200 or the IAB node 300. For example, the UE 100 is a mobile phone terminal and/or a tablet terminal, a laptop PC, a sensor or an apparatus provided in a sensor, a vehicle or an apparatus provided in a vehicle, or a flight vehicle or an apparatus provided in a flight vehicle. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

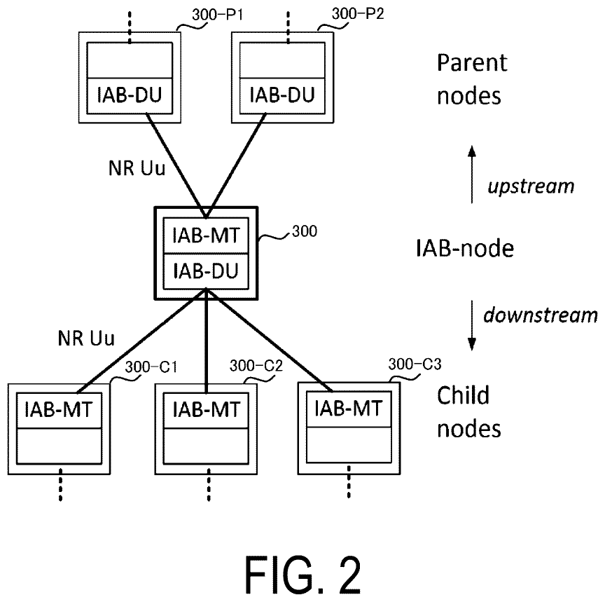

FIG. 2 is a diagram illustrating an example of a relationship between the IAB node 300, parent nodes, and child nodes.

Each IAB node 300 includes an IAB-DU equivalent to abase station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent JAB node or the donor node 200. A radio link between the IAB-MT and the parent node is referred to as a backhaul link (BH link). FIG. 2 illustrates an example in which the parent nodes of the JAB node 300 are IAB nodes 300-P1 and 300-P2. A direction toward the parent nodes is referred to as upstream. From the perspective of the UE 100, the upper node of the UE 100 may correspond to a parent node.

Adjacent nodes (that is, lower nodes) on the NR access interface of the IAB-DU are referred to as child nodes. The IAB-DU manages the cell similarly to the gNB 200. The IAB-DU terminates the NR Uu radio interface to the UE 100 and the lower IAB nodes. The IAB-DU supports the F1 protocol to the CU of the donor node 200-1. FIG. 2 illustrates an example in which the child nodes of the IAB node 300 are IAB nodes 300-Cl to 300-C3, but the child node of the IAB node 300 may also include the UE 100. A direction toward the child nodes is referred to as downstream.

All of the IAB nodes 300 connected to the donor node 200 via one or more hops form a Directed Acyclic Graph (DAG) topology (hereinafter may be referred to as “topology”) with the donor node 200 as the root. In this topology, as illustrated in FIG. 2, adjacent nodes on the IAB-DU interface are child nodes, and adjacent nodes on the IAB-MT interface are parent nodes. For example, the donor node 200 concentratedly performs management of resources, topology, and routes of IAB topology. The donor node 200 is a gNB that provides network access to the UE 100 via a network of backhaul links and access links.

### (1.2) Configuration of Network Node

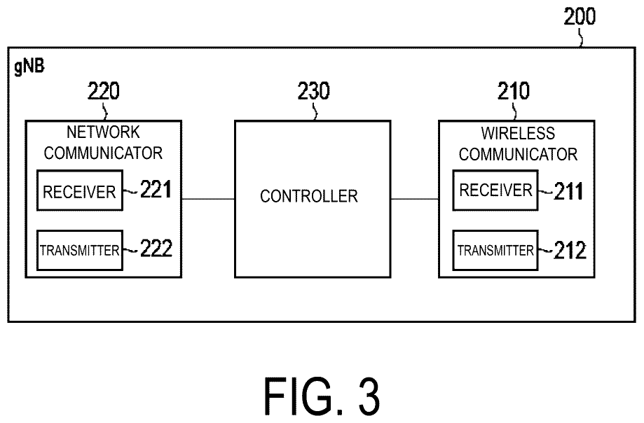

A configuration of the gNB 200, which is a network node according to the embodiment, will be described. FIG. 3 is a diagram illustrating a configuration example of the gNB 200. The gNB 200 includes a wireless communicator 210, a network communicator 220, and a controller 230.

The wireless communicator 210 performs wireless communication with the UE 100 and wireless communication with the IAB node 300. The wireless communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the signal from the antenna.

The network communicator 220 performs wired communication (or wireless communication) with the 5GC 10 and wired communication (or wireless communication) with the other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 230 may perform all of the processing and operations in the gNB 200 in each embodiment to be described below.

### (1.3) Configuration of Relay Node

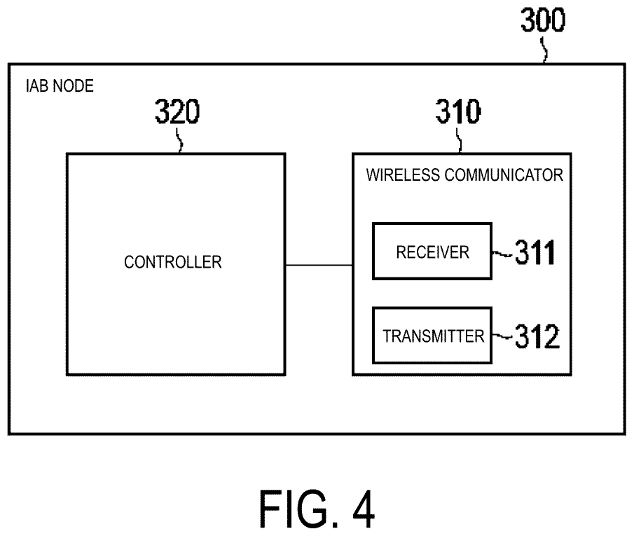

A configuration of the IAB node 300, which is a relay node according to the embodiment, will be described. FIG. 4 is a diagram illustrating a configuration example of the IAB node 300. The IAB node 300 includes a wireless communicator 310 and a controller 320. The IAB node 300 may include a plurality of the wireless communicators 310.

The wireless communicator 310 performs wireless communication (BH link) with the gNB 200 and wireless communication (access link) with the UE 100. The wireless communicator 310 for BH link communication and the wireless communicator 310 for access link communication may be provided separately.

The wireless communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 320 may perform all of the processing and operations in the IAB node 300 in each embodiment to be described below.

### (1.4) Configuration of User Equipment

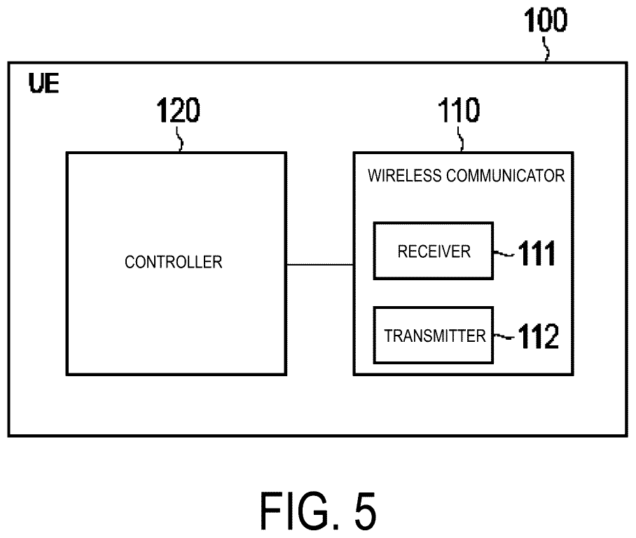

A configuration of the UE 100, which is a user equipment according to the embodiment, will be described. FIG. 5 is a diagram illustrating a configuration example of the UE 100. The UE 100 includes a wireless communicator 110 and a controller 120.

The wireless communicator 110 performs wireless communication in an access link, that is, wireless communication with the gNB 200 and wireless communication with the IAB node 300. The wireless communicator 110 may also perform wireless communication in a side link, that is, wireless communication with the other UEs 100. The wireless communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 120 may perform all of the processing in the UE 100 in each embodiment to be described below.

### (1.5) Configuration of Protocol Stack

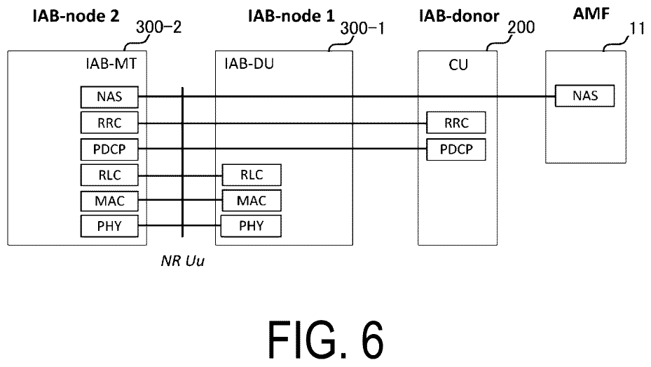

A configuration of a protocol stack according to the embodiment will be described. FIG. 6 is a diagram illustrating an example of a protocol stack relating to RRC connection and NAS connection of the IAB-MT.

The IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs encoding/decoding, modulation/demodulation, antenna mapping/demapping, and resource mapping/demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (Hybrid Automatic Repeat reQuest (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (a transport block size and a Modulation and Coding Scheme (MCS)) and assigned resource blocks for an uplink and a downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of the radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer, which is located above the RRC layer, performs session management, mobility management, and the like. NAS signaling is transmitted between the NAS layer of the IAB-MT of the IAB node 300-2 and the AMF 11.

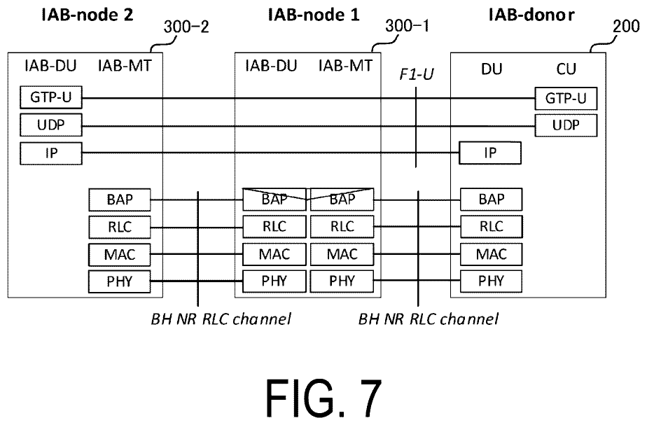

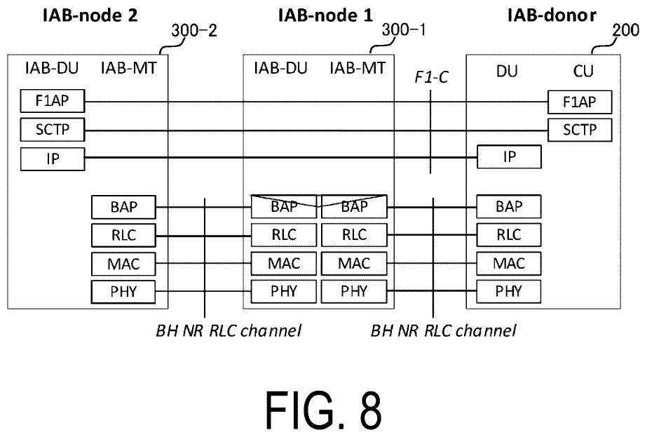

FIG. 7 is a diagram illustrating a protocol stack relating to the F1-U protocol. FIG. 8 is a diagram illustrating a protocol stack relating to the F1-C protocol. Here, an example in which the donor node 200 is divided into a CU and a DU is illustrated.

As illustrated in FIG. 7, the IAB-MT of the IAB node 300-2, the IAB-DU of the IAB node 300-1, the IAB-MT of the IAB node 300-1, and the DU of the donor node 200 each include a Backhaul Adaptation Protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a Protocol Data Unit (PDU) of the BAP layer is transmitted by a backhaul RLC channel (BH NR RLC channel). A plurality of backhaul RLC channels is configured in each BH link, thus enabling traffic prioritization and Quality of Service (QoS) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and an UDP layer illustrated in FIG. 7.

In the following, processing or operations performed in the IAB-DU and IAB-MT of the IAB may be simply described as processing or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processing or operations of the DU or CU of the donor node 200 may also be described simply as processing or operations of the “donor node”. An upstream direction and an uplink (UL) direction may be used without distinction. A downstream direction and a downlink (DL) direction may be used without distinction.

### (1.6) Mobile IAB Node

At present, 3GPP has started to study the introduction of a mobile IAB node. The mobile IAB node is, for example, an IAB node that is moving. The mobile IAB node may be a movable IAB node. The mobile IAB node may be an IAB node that is capable of moving. The mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving according to the movement of the mobile IAB node. For example, a case is assumed in which a user (or UE 100) riding a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be an IAB node that is stationary. The intermediate IAB node may be a stationary IAB node. The intermediate IAB node may be an IAB node that is stationary (or does not move) in a state of being installed at its installation location. The intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. A connection destination may be the intermediate IAB node. The connection destination may be the donor node 200.

In the following, the movement (migration) of the mobile IAB node and the handover of the mobile IAB node may be used without distinction. In the following, the mobile IAB node may be a “mobile IAB node”, or may be “migrating IAB node”. In either case, the node may be referred to as a mobile IAB node. The mobile IAB node may be a mobile relay node.

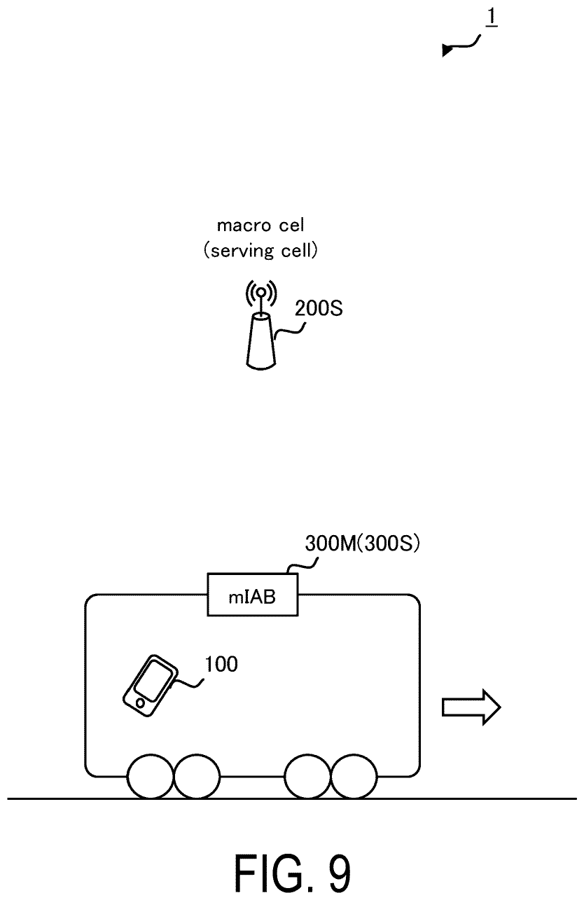

FIG. 9 is a diagram illustrating an example of an application scenario of the mobile IAB node according to the embodiment.

In the illustrated example, a mobile IAB node (mIAB node) 300M is provided in a movable vehicle (for example, a vehicle such as a train or a bus). The UE 100 is located in a movable vehicle and is in an RRC connected state connected to a cell of the mobile IAB node 300M. The cell that the mobile IAB node 300M manages may be referred to as a mobile IAB cell (mIAB cell). The IAB-MT of the mobile IAB node 300M is in the RRC connected state connected to a cell (a stationary cell or a macro cell) of the gNB 200. In the example illustrated in the drawing, the gNB 200 is the donor node of the mobile IAB node 300M. The donor node is the gNB 200 (or parent IAB node) to which the IAB node 300 connects. The mobile IAB node 300M performs a relay operation of relaying communication performed between the gNB 200 (donor node) and the UE 100.

In the embodiment, the mobile IAB node 300M may be an IAB node 300 that is configured as a mobile IAB node by a network (the donor node, for example). When configured as a mobile IAB node by the network, the IAB node 300 functions (operates) as the mobile IAB node 300M. The mobile IAB node 300M may be an IAB node 300 that does not support a child node. The mobile IAB node 300M may be an IAB node 300 newly introduced in Release 18 of the 3GPP standard.

A state in which an IAB node 300 is configured as a mobile IAB node may be referred to as a mobile IAB state (mobile IAB mode).

On the other hand, when configured as a stationary IAB node by the network, an IAB node 300 functions (operates) as a stationary IAB node. A stationary IAB node may be a conventional IAB node 300, that is, an IAB node 300 of Release 17 or earlier (Release 16 or 17) of the 3GPP standard. A stationary IAB node may be an IAB node 300 supporting a child node. A state in which an IAB node 300 is configured as a stationary IAB node may be referred to as a stationary IAB state (stationary IAB mode).

Note that, in the embodiment, the donor node (gNB 200) may broadcast both the conventional “IAB Support IE” and the “mobile IAB Support IE” of Release 18 in the system information block type 1 (SIB1). That is, the donor node (gNB 200) may support both the conventional IAB node (stationary IAB node) and the mobile IAB node introduced in Release 18.

### (1.7) System Operation According to First Embodiment

Operations of the cellular communication system 1 according to the first embodiment will be described.

### (1.7.1) Operation Overview

An IAB node 300 cannot operate in both modes of a stationary IAB node and a mobile IAB node at the same time. Hence, the donor node performs either one of the stationary IAB node configuration or the mobile IAB node configuration for the IAB node 300. That is, the donor node can perform the configuration on only one of the stationary IAB node or the mobile IAB node for one IAB node 300. However, it is difficult for the donor node to recognize a situation such as whether the IAB node 300 is installed in a vehicle, or whether the vehicle is moving. Hence, there is a problem that it is difficult for the donor node to appropriately determine which of the stationary IAB node configuration and the mobile IAB node configuration is to be performed for the IAB node 300.

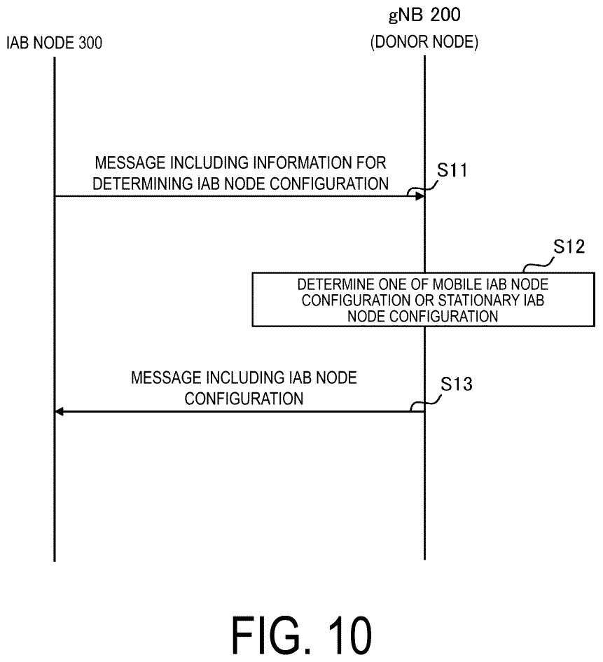

FIG. 10 is a diagram illustrating an operation overview of the cellular communication system 1 according to the first embodiment.

In step S11, the IAB node 300 transmits, to the donor node (gNB 200), a message including information for determining one of the mobile IAB node configuration or the stationary IAB node configuration as the configuration of the IAB node 300 itself. The donor node (gNB 200) receives the message from the IAB node 300.

In step S12, the donor node (gNB 200), specifically, the CU of the donor node (gNB 200), determines one of the mobile IAB node configuration or the stationary IAB node configuration as the configuration of the IAB node 300 based on the information included in the message of step S11.

In step S13, the donor node (gNB 200) transmits, to the IAB node 300, a message (RRC Reconfiguration message, for example) including configuration information indicating configuration content (IAB node configuration) determined in step S12. The IAB node 300 receives the message from the donor node (gNB 200). The IAB node 300 functions (operates) as a mobile IAB node or a stationary IAB node based on the configuration information included in the message of step S12.

As described above, in the first embodiment, the IAB node 300 transmits, to the donor node (gNB 200), a message including information for determining one of the mobile IAB node configuration or the stationary IAB node configuration as the configuration of the IAB node 300 itself. Thus, the donor node (gNB 200) can appropriately determine which of the stationary IAB node configuration or the mobile IAB node configuration is to be performed for the IAB node 300.

For example, in step S11, the IAB node 300 may transmit, to the donor node (gNB 200), a message including a first indication (also referred to as a “stationary IAB node indication”) indicating that the stationary IAB node configuration is preferred or requested according to the preference or request for the stationary IAB node configuration. The first indication may be preference information (notification of preference) indicating that the IAB node 300 prefers the stationary IAB node configuration. The first indication may be request information (notification of necessity) indicating that the IAB node 300 needs the stationary IAB node configuration. Thus, the donor node (gNB 200) can recognize that the IAB node 300 prefers or requests the stationary IAB node configuration upon reception of the first indication.

Alternatively, in step S11, the IAB node 300 may transmit, to the donor node (gNB 200), a message including a second indication (also referred to as a “mobile IAB node indication”) indicating that the mobile IAB node configuration is preferred or requested according to the preference or request for the mobile IAB node configuration. The second indication may be preference information (notification of preference) indicating that the IAB node 300 prefers the mobile IAB node configuration. The second indication may be request information (notification of necessity) indicating that the IAB node 300 needs the mobile IAB node configuration. Thus, the donor node (gNB 200) may recognize that the IAB node 300 prefers or requests the mobile IAB node configuration upon reception of the second indication.

Alternatively, in step S11, the IAB node 300 may transmit, to the donor node (gNB 200), a message including a first indication indicating that the stationary IAB node configuration is preferred or requested and a second indication indicating that the mobile IAB node configuration is preferred or requested, according to there being no configuration preferred or requested as the configuration of the IAB node 300 itself (that is, either the mobile IAB node configuration or the stationary IAB node configuration is acceptable). Thus, the donor node (gNB 200) may recognize that there is no configuration preferred or requested as the configuration of the IAB node 300 upon reception of both the first indication and the second indication. Note that the IAB node 300 may transmit, to the donor node (gNB 200), a message including a third indication indicating that either the mobile IAB node configuration or the stationary IAB node configuration is acceptable according to there being no configuration preferred or requested as the configuration of the IAB node 300 itself (that is, either the mobile IAB node configuration or the stationary IAB node configuration is acceptable).

In step S11, the IAB node 300 may transmit, to the donor node (gNB 200), a message including movement information indicating the moving state of the IAB node 300 itself. Thus, the donor node (gNB 200) may determine which of the stationary IAB node configuration and the mobile IAB node configuration is performed for the IAB node 300 in consideration of the moving state of the IAB node 300 based on the movement information. Here, the movement information may be information indicating the movement speed of the IAB node 300. The movement information may be information indicating a possibility of the IAB node 300 to move (for example, the capability of the IAB node 300 to move).

In step S11, the IAB-MT of the IAB node 300 may transmit to the CU of the donor node (gNB 200) a message including information for determining one of the mobile IAB node configuration or the stationary IAB node configuration as the configuration of the IAB node 300 itself.

The message may be an RRC message being a message of the RRC layer. For example, the message may be Msg5 used in a random access procedure. Msg5 may be an RRC Setup Complete message used to confirm that the establishment of an RRC connection has been successfully completed. Msg5 may be an RRC Resume Complete message used to confirm that the resumption of an RRC connection has been successfully completed.

Alternatively, the message may be a message different from Msg5. The message different from Msg5 may be a UE Assistance Information message, for example. The UE Assistance Information message is an RRC message used to notify the network of UE Assistance Information. In the case above, the IAB node 300 may start a timer at the time of transmission of the message (UE Assistance Information message), and may perform control so as not to transmit the next message (specifically, the UE Assistance Information message including information for determining one of the mobile IAB node configuration or the stationary IAB node configuration) while the timer is running. Thus, the UE Assistance Information message, including the information for determining one of the mobile IAB node configuration or the stationary IAB node configuration, being frequently transmitted can be suppressed.

Alternatively, in step S11, the IAB-DU of the IAB node 300 may transmit, to the CU of the donor node (gNB 200), a message including information for determining one of the mobile IAB node configuration or the stationary IAB node configuration as the configuration of the IAB node 300 itself. The message may be an F1 message being a message of an F1 layer (F1-C protocol).

In step S13, the CU of the donor node (gNB 200) may transmit to the IAB-MT of the IAB node 300 an RRC message including information for specifying whether to configure the IAB node 300 as a mobile IAB node. The IAB-MT of the IAB node 300 can recognize, upon reception of the RRC message, whether the IAB node 300 itself is configured as a mobile IAB node or a stationary IAB node.

### (1.7.2) Specific Operation Example

As specific operation examples of the cellular communication system 1 according to the first embodiment, a first operation pattern to a fourth operation pattern will be described. Each of the first to fourth operation patterns may be performed independently, or two or more operation patterns may be combined and performed.

### (1.7.2.1) First Operation Pattern

The donor node (gNB 200) determines whether to perform the mobile IAB node configuration for the IAB node 300. Here, when the IAB node 300 performs initial access (that is, a random access procedure), the IAB-MT of the IAB node 300 is in the RRC idle state. Hence, the donor node (gNB 200) does not know information on whether the IAB node 300 that has accessed the donor node is installed in a vehicle (such as train), whether the IAB node 300 is moving (whether there is a possibility to move), and the like. In the first operation pattern, a preference or request for whether to be configured as a mobile IAB node is expressed by two indications of Msg5, that is, the first indication and the second indication.

In the first operation pattern according to the first embodiment, when the IAB-MT of the IAB node 300 prefers to be configured as a mobile IAB node, the IAB-MT transmits the second indication (mobile IAB node indication) with Msg5. When the IAB-MT of the IAB node 300 may be configured as either a stationary IAB node or a mobile IAB node (that is, no preference), the IAB-MT of the IAB node 300 transmits both the first indication (stationary IAB node indication) and the second indication (mobile IAB node indication) with Msg5.

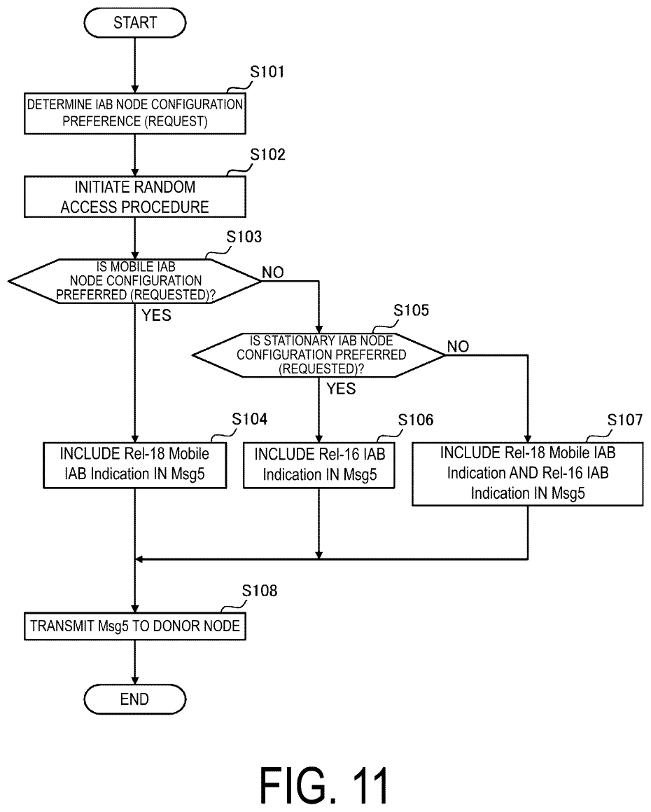

FIG. 11 is a flowchart indicating an example of an operation of the IAB node 300 in the first operation pattern according to the first embodiment. Here, it is assumed that the IAB-MT of the IAB node 300 is in the RRC idle state at the start of the operation.

In step S101, the IAB node 300 determines the preference (request) for the IAB node configuration of the IAB node 300 itself based on the IAB node 300 itself operating mobile IAB node functionality and/or the IAB node 300 itself being installed in an environment where an operation as a mobile IAB node is suitable (for example, installed in a train, or the like). The information above may be written to a memory of the IAB node 300, for example, at the time of factory shipment and/or installation of the IAB node 300. An upper layer (NAS or application) may notify an AS (IAB-MT of the IAB node 300) of the information above. Note that step S101 may be performed after step S102.

In step S102, the IAB-MT of the IAB node 300 initiates an RRC connection setup procedure (that is, a random access procedure for initial access).

Here, the random access procedure includes random access preamble transmission (Msg1) from the IAB-MT of the IAB node 300 to the donor node (gNB 200), random access response transmission (Msg2) from the donor node (gNB 200) to the IAB-MT of the IAB node 300, RRC Setup Request message transmission (Msg3) from the IAB-MT of the IAB node 300 to the donor node (gNB 200), RRC Setup message transmission (Msg4) from the donor node (gNB 200) to the IAB-MT of the IAB node 300, and RRC Setup Complete message transmission (Msg5) from the IAB-MT of the IAB node 300 to the donor node (gNB 200). Note that the IAB-MT of the IAB node 300 transitions, upon reception of the RRC Setup message (Msg4), from the RRC idle state to the RRC connected state.

In step S103, the IAB-MT of the IAB node 300 determines whether to prefer (request) the mobile IAB node configuration. When the IAB-MT of the IAB node 300 prefers (requests) the mobile IAB node configuration (step S103: YES), the IAB-MT of the IAB node 300 includes the second indication (mobile IAB node indication) in Msg5 (RRC Setup Complete message) in step S104.

On the other hand, when the IAB-MT of the IAB node 300 prefers (requests) the stationary IAB node configuration (step S103: NO, step S105: YES), the IAB-MT of the IAB node 300 includes the first indication (stationary IAB node indication) in Msg5 (RRC Setup Complete message) in step S106.

When the IAB-MT of the IAB node 300 may be configured with either the mobile IAB node configuration or the stationary IAB node configuration (step S105: NO), in step S107, the IAB-MT of the IAB node 300 includes both the first indication (stationary IAB node indication) and the second indication (mobile IAB node indication) in Msg5 (RRC Setup Complete message).

In step S108, the IAB-MT of the IAB node 300 transmits, to the donor node (gNB 200), Msg5 (RRC Setup Complete message) including the indication. Thus, the donor node (gNB 200) can recognize whether the IAB node 300 prefers (requests) to be configured as a mobile IAB, or the like, by the indication included in Msg5. The donor node (gNB 200), then, can appropriately perform configuration (for example, RRC configuration, F1 configuration, or the like) for the IAB node 300 in consideration of the preference (request) described above.

### (1.7.2.2) Second Operation Pattern

In the second operation pattern according to the first embodiment, the IAB-MT of the IAB node 300 transmits, to the donor node (gNB 200), Msg5 including movement information indicating the moving state of the IAB-MT of the IAB node 300 itself. The movement information is not only for notifying the gNB 200 of the current moving state of the IAB node 300 but also of the possibility (capability) of movement in the future.

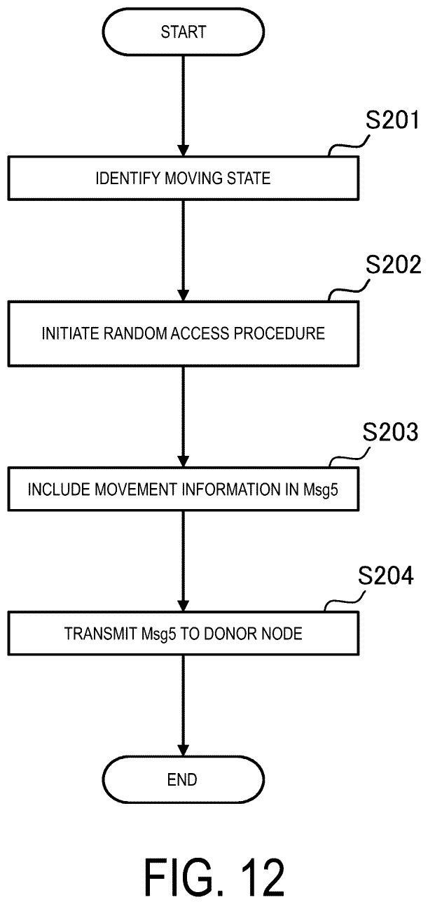

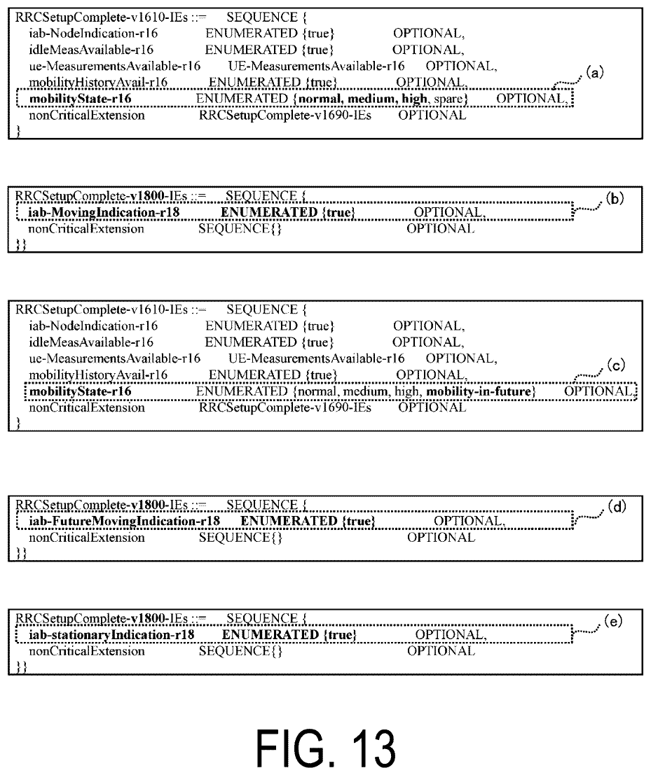

FIG. 12 is a flowchart illustrating an example of an operation of the IAB node 300 in the second operation pattern according to the first embodiment. Here, it is assumed that the IAB-MT of the IAB node 300 is in the RRC idle state at the start of the operation. FIG. 13 is a diagram for describing Msg5 (RRC Setup Complete message) in the second operation pattern according to the first embodiment.

As illustrated in FIG. 12, in step S201, the IAB node 300 identifies that the IAB node 300 itself is operating the mobile IAB node functionality and/or that the IAB node 300 itself is installed in an environment where an operation as a mobile IAB node is suitable (for example, installed in a vehicle such as a train), and recognizes a moving state such as current movement speed and/or future possibility of movement (capability of movement) of the IAB node 300 itself. Note that step S201 may be performed after step S202.

Note that the IAB node 300 may detect the state of being installed in a vehicle by using at least one of the movement speed of the IAB node 300 itself or the change in propagation environment, for example. The IAB node 300 can recognize the movement speed with periodical positioning, for example, with the positioning using a Global Navigation Satellite System (GNSS) receiver. The IAB node 300 may recognize that the IAB node 300 itself is installed in a vehicle based on a fact that the movement speed of the IAB node 300 itself is high (for example, the movement speed exceeds a threshold value). The IAB node 300 may estimate the movement speed of the IAB node 300 itself from a Doppler measurement value.

In step S202, the IAB-MT of the IAB node 300 initiates an RRC connection setup procedure (that is, a random access procedure for initial access).

In step S203, the IAB-MT of the IAB node 300 includes movement information indicating the moving state identified in step S201 in Msg5 (RRC Setup Complete message).

For example, when the IAB node 300 is currently moving, the IAB-MT of the IAB node 300 may include information indicating the movement speed in Msg5 (RRC Setup Complete message) as illustrated in (a) of FIG. 13. In the illustrated example, the IAB-MT of the IAB node 300 includes “mobilityState”, which is an information element indicating the degree (normal, medium, high) of the movement speed of the IAB node 300 itself, in Msg5 (RRC Setup Complete message).

When the IAB node 300 is currently moving, the IAB-MT of the IAB node 300 may include information indicating that the IAB node 300 is moving in Msg5 (RRC Setup Complete message) as illustrated in (b) of FIG. 13. In the illustrated example, the IAB-MT of the IAB node 300 includes “iab-MovingIndication”, which is an information element indicating that the IAB node 300 is moving, in Msg5 (RRC Setup Complete message).

In a case that the IAB node 300 (although not currently moving) has a possibility (has capability) of moving in the future, the IAB-MT of the IAB node 300 may include information indicating that the IAB node 300 has the possibility (has the capability) of moving in the future in Msg5 (RRC Setup Complete message) as illustrated in (c) or (d) of FIG. 13. In the example of (c) of FIG. 13, the IAB-MT of the IAB node 300 sets “mobility-in-future”, which is an information element indicating that there is a possibility (there is capability) of moving in the future, in “mobilityState” of Msg5 (RRC Setup Complete message). In the example of (d) of FIG. 13, the IAB-MT of the IAB node 300 includes “iab-FutureMovingIndication”, which is an information element indicating that there is a possibility (there is capability) of moving in the future, in Msg5 (RRC Setup Complete message) as an information element different from “mobility-in-future”.

When the IAB node 300 does not move (has no moving capability), the IAB-MT of the IAB node 300 may include information indicating that the IAB node 300 does not move (has no moving capability) in Msg5 (RRC Setup Complete message) as illustrated in (e) of FIG. 13. In the illustrated example, the IAB-MT of the IAB node 300 includes “iab-stationaryIndication”, which is an information element indicating that the IAB node 300 does not move (has no moving capability), in Msg5 (RRC Setup Complete message) as an information element different from “mobility-in-future”.

In step S204, the IAB-MT of the IAB node 300 transmits, to the donor node (gNB 200), Msg5 (RRC Setup Complete message) including the movement information. Thus, the donor node (gNB 200) can recognize the moving state of the IAB node 300 by the movement information included in Msg5. The donor node (gNB 200), then, can appropriately perform configuration (for example, RRC configuration, F1 configuration, or the like) such as whether to configure the IAB node 300 as a mobile IAB or the like, in consideration of the moving state above.

### (1.7.2.3) Third Operation Pattern

In the third operation pattern according to the first embodiment, the IAB-MT of the IAB node 300 transmits, to the donor node (gNB 200), the indication (the first indication and/or the second indication) according to the first operation pattern described above with a UE Assistance Information message being a message different from Msg5. The IAB-MT of the IAB node 300 may transmit, to the donor node (gNB 200), the movement information according to the above-described second operation pattern with a UE Assistance Information message. The UE Assistance Information message including the indication and/or the movement information may be restricted by a timer from being frequently transmitted.

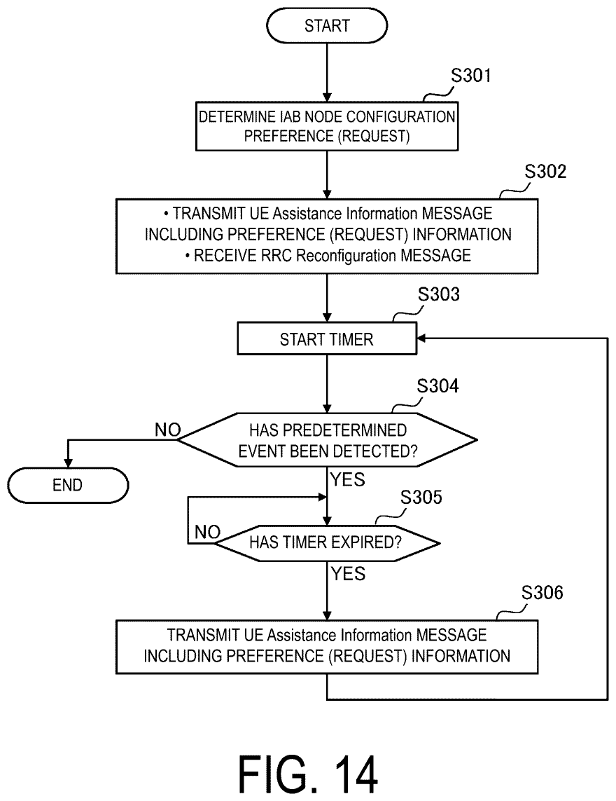

FIG. 14 is a flowchart illustrating an example of an operation of the IAB node 300 in the third operation pattern according to the first embodiment. Here, it is assumed that the IAB-MT of the IAB node 300 is in the RRC connected state at the start of the operation.

In step S301, the IAB-MT of the IAB node 300 determines information (indication and/or movement information) for determining one of the mobile IAB node configuration or the stationary IAB node configuration as the configuration of the IAB node 300 itself, the same as in the first operation pattern and the second operation pattern described above.

In step S302, the IAB-MT of the IAB node 300 transmits, to the donor node (gNB 200), a message (here, the UE Assistance Information message) including an indication and/or movement information. The donor node (gNB 200) determines configuration (for example, RRC configuration, F1 configuration, or the like) such as whether to configure the IAB node 300 as a mobile IAB based on the indication and/or the movement information included in Msg5, and transmits, to the IAB-MT of the IAB node 300, an RRC Reconfiguration message including information indicating the configuration. The IAB-MT of the IAB node 300 receives the RRC Reconfiguration message. Note that the configuration may or may not match the notification content of step S301. For example, the IAB node 300 may prefer the mobile IAB configuration, but the donor node (gNB 200) may perform the stationary IAB node configuration.

In step S303, the IAB-MT of the IAB node 300 starts a timer when transmitting the UE Assistance Information message or receiving the RRC Reconfiguration message in step S302. The RRC Reconfiguration message may include a setting value (timer value) determining the time length of the timer. In the case above, the IAB-MT of the IAB node 300 may start the timer in which the timer value is set when receiving the RRC Reconfiguration message.

In step S304, the IAB-MT of the IAB node 300 determines whether a predetermined event has been detected, the predetermined event that triggers transmission of the UE Assistance Information message including the indication and/or movement information. The predetermined event may be any one of the following:
Preference (request) for the IAB node configuration has changed
The moving state has changed
The IAB node configuration by the RRC Reconfiguration message is different from the preference (request) of the IAB-MT of the IAB node 300 itself
Periodic Trigger (periodic transmission)

When the predetermined event is detected, in step S305, the IAB-MT of the IAB node 300 determines whether the timer, which has been started in step S303, has expired. When the timer is running (step S305: NO), the IAB-MT of the IAB node 300 suspends transmission (does not perform transmission) of the UE Assistance Information message including the indication and/or the movement information.

On the other hand, when the timer has expired (step S305: YES), in step S306, the IAB-MT of the IAB node 300 transmits, to the donor node (gNB 200), the UE Assistance Information message including an indication and/or movement information. Subsequently, the processing returns to step S303.

### (1.7.2.4) Fourth Operation Pattern

In the fourth operation pattern according to the first embodiment, the IAB-DU of the IAB node 300, not the IAB-MT of the IAB node 300, transmits, to the donor node (gNB 200), a message including the indication (the first indication and/or the second indication) according to the first operation pattern. The message may be an F1 Setup Request message, for example. The IAB-DU of the IAB node 300 may transmit to the donor node (gNB 200) a message (F1 Setup Request message) including the movement information according to the second operation pattern.

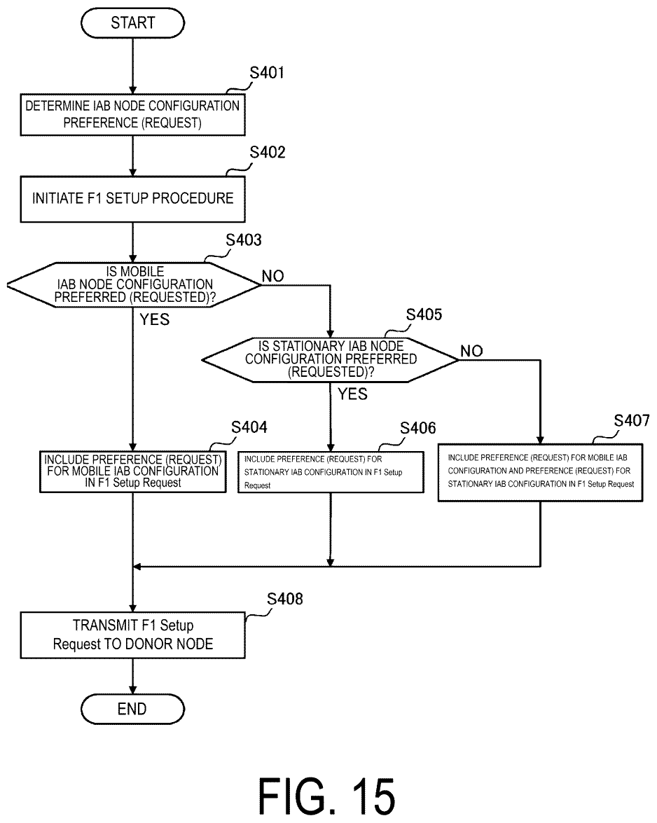

FIG. 15 is a flowchart illustrating an example of an operation of the IAB node 300 in the fourth operation pattern according to the first embodiment. Here, an example in which the indication is included in the F1 Setup Request message will be described, but the movement information may be included in the F1 Setup Request message.

In step S401, the IAB node 300 determines the preference (request) of the IAB node 300 itself for the IAB node configuration based on the IAB node 300 itself operating the mobile IAB node functionality and/or the IAB node 300 itself being installed in an environment where an operation as a mobile IAB node is suitable (for example, installed in a train, or the like). The information above may be written to a memory of the IAB node 300, for example, at the time of factory shipment and/or installation of the IAB node 300. Note that step S401 may be performed after step S402.

In step S402, the IAB-DU of the IAB node 300 initiates an F1 setup procedure to set up an F1 interface with the donor node (gNB 200).

In step S403, the IAB-DU of the IAB node 300 determines whether to prefer (request) the mobile IAB node configuration. When the IAB-DU of the IAB node 300 prefers (requests) the mobile IAB node configuration (step S403: YES), in step S404, the IAB-DU of the IAB node 300 includes the second indication (mobile IAB node indication) in the F1 Setup Request message.

On the other hand, when the IAB node 300 prefers (requests) the stationary IAB node configuration (step S403: NO, step S405: YES), in step S406, the IAB-DU of the IAB node 300 includes the first indication (stationary IAB node indication) in the F1 Setup Request message.

When the IAB-DU of the IAB node 300 may be configured with either the mobile IAB node configuration or the stationary IAB node configuration (step S405: NO), in step S407, the IAB-DU of the IAB node 300 includes both the first indication (stationary IAB node indication) and the second indication (mobile IAB node indication) in the F1 Setup Request message. Alternatively, the IAB-DU of the IAB node 300 may include a third indication indicating that either the mobile IAB node configuration or the stationary IAB node configuration is acceptable in the F1 Setup Request message.

In step S408, the IAB-DU of the IAB node 300 transmits, to the CU of the donor node (gNB 200), the F1 Setup Request message including the indication. Thus, the donor node (gNB 200) can recognize whether the IAB node 300 prefers (requests) configuration as a mobile IAB, or the like, by the indication included in the F1 Setup Request message. The donor node (gNB 200), then, can appropriately perform configuration (for example, RRC configuration, F1 configuration, or the like) for the IAB node 300 in consideration of the preference (request) described above.

### (1.8) Variation of First Embodiment

In the first embodiment described above, the IAB node 300 can recognize that the IAB node 300 itself is configured as a mobile IAB node according to the IAB configuration information (information element) for Release 18 being included, as the RRC configuration, the F1 configuration, and the like for the IAB node 300 itself. However, restricting that Release 18 functionality should not be applied to a stationary IAB node may lower the degree of freedom of deployment. Further, it is also conceivable to apply only Release 16 or 17 functionality to the IAB node 300 and to operate the IAB node 300 as a mobile IAB node. Hence, in the present variation, the donor node (gNB 200) includes an information element (also referred to as “specifying information”) for specifying whether to configure the IAB node 300 as a mobile IAB node in RRC Reconfiguration and explicitly notifies the IAB node 300 of the RRC Reconfiguration. The IAB-MT of the IAB node 300 can recognize whether the movement is permitted based on the RRC configuration (specifying information) above.

In the present variation, the donor node (gNB 200) may broadcast both the conventional “IAB Support IE” and the “mobile IAB Support IE” of Release 18 with SIB1. That is, the donor node (gNB 200) may support both the conventional IAB node (stationary IAB node) and the mobile IAB node introduced in Release 18. The IAB-MT of the IAB node 300 may transmit to the donor node (gNB 200) both the first indication and the second indication with Msg5 during connection processing (random access procedure). The donor node (gNB 200) determines whether to operate (configure) the IAB node 300 as a stationary IAB node or to operate (configure) the IAB node 300 as a mobile IAB node, and transmits, to the IAB-MT of the IAB node 300, an RRC reconfiguration message according to the determination. Here, the RRC Reconfiguration message includes an information element indicating that the IAB node 300 is permitted to move or an information element indicating that the IAB node 300 is operated as a mobile IAB node. The IAB-MT of the IAB node 300 recognizes whether the IAB-MT of the IAB node 300 itself is configured (permitted, operated) as a stationary IAB node or configured (permitted, operated) as a mobile IAB node, based on the information element (or the presence or absence of the information element).

### (2) Second Embodiment

A system operation according to the second embodiment will be described, focusing on differences from the first embodiment described above. The system operation according to the second embodiment may be implemented in combination with the system operation according to the first embodiment.

### (2.1) Operation Overview

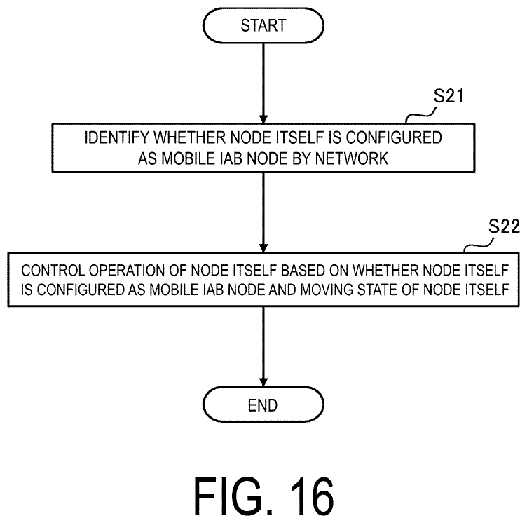

FIG. 16 is a flowchart illustrating an operation overview of the IAB node 300 according to the second embodiment. In the second embodiment, it is assumed that the IAB-MT of the IAB node 300 is in the RRC connected state.

In step S21, the IAB node 300 identifies whether the IAB node 300 itself is configured as a mobile IAB node by the network (donor node).

In step S22, the IAB node 300 controls the operation of the IAB node 300 itself based on whether the IAB node 300 itself is configured as a mobile IAB node and the moving state of the IAB node 300 itself.

As described in the variation of the above-described first embodiment, the IAB node 300 may receive, from the donor node (gNB 200), an RRC message (RRC Reconfiguration message) including information for identifying whether to configure the IAB node 300 as a mobile IAB node before step S21. In step S21, the IAB node 300 may identify whether the IAB node 300 itself is configured as a mobile IAB node based on information included in the RRC message (RRC Reconfiguration message). Alternatively, in step S21, the IAB node 300 may identify whether the IAB node 300 itself is configured as a mobile IAB node based on whether the IAB configuration information (information element) for Release 18 is included in the RRC message (RRC Reconfiguration message).

In step S22, when the IAB node 300 itself is configured as a stationary IAB node and the movement of the IAB node 300 itself is detected, the IAB node 300 may perform predetermined processing including at least one of message transmission to the donor node (gNB 200) or stop of the relay operation. Thus, it is possible to suppress the IAB node 300 itself from operating as a stationary IAB node in a situation where it has become inappropriate for the IAB node 300 itself to operate as a stationary IAB node.

Here, the predetermined processing may include, for example, transmitting, to the donor node (gNB 200), a message for requesting release of the RRC connection between the donor node (gNB 200) and the IAB node 300, cancellation of the RRC configuration, or reconfiguration of the RRC configuration. The predetermined processing may include transmitting, to the donor node (gNB 200), a message for notifying the donor node (gNB 200) of the movement. The predetermined processing may include stopping at least one of signal transmission to the donor node (gNB 200) or signal transmission to the UE 100. The predetermined processing may include broadcasting of information for performing access restriction of the UE 100 to the IAB node 300.

On the other hand, when the IAB node 300 is configured as a mobile IAB node and the IAB node 300 is detected to be stationary (stopped), the IAB node 300 may transmit a message to the donor node (gNB 200) in step S22. Thus, it is possible to suppress the IAB node 300 itself from operating as a mobile IAB node in a situation where it has become inappropriate for the IAB node 300 itself to operate as a mobile IAB node.

Here, as the message transmission to the donor node (gNB 200), the IAB node 300 may transmit, to the donor node (gNB 200), a message for requesting a change to the configuration of a stationary IAB node different from a mobile IAB node. The IAB node 300 may transmit a message for notifying the donor node (gNB 200) of the stationariness as the message transmission to the donor node (gNB 200). Here, the IAB node 300 may resume the signal transmission, which has been stopped according to the above-described movement detection. The IAB node 300 may cancel the access restriction, which has been performed according to the above-described movement detection.

### (2.2) Specific Operation Example

As specific operation examples of the cellular communication system 1 according to the second embodiment, a first operation pattern and a second operation pattern will be described.

### (2.2.1) First Operation Pattern

In the first operation pattern according to the second embodiment, the IAB node 300 configured as a stationary IAB node performs the predetermined processing in response to detecting the movement of the IAB node 300 itself (for example, the movement of a vehicle in which the IAB node 300 is installed). The predetermined processing includes at least one of transmitting a message requesting connection release or de-configuration to the donor node (gNB 200), transmitting a message notifying the donor node (gNB 200) that movement is detected, or stop of transmission (transmitter) of the IAB node 300 itself by the IAB node 300. Note that the IAB node 300 configured as a stationary IAB node may perform the predetermined processing in response to the fact that the state in which the IAB node 300 itself is moving continues for a predetermined time.

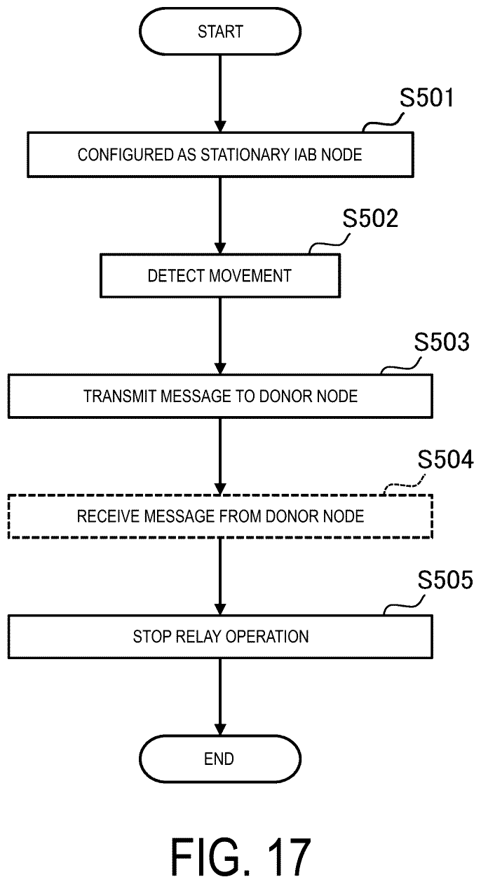

FIG. 17 is a flowchart illustrating an example of an operation of the IAB node 300 in the first operation pattern according to the second embodiment.

In step S501, the IAB node 300 is configured as a stationary IAB node.

In step S502, the IAB node 300 detects that the IAB node 300 itself is moving (has started moving). For example, the IAB node 300 may detect movement by using a GNSS receiver of the IAB node 300 itself. The IAB node 300 may detect movement by receiving speed information from a vehicle (moving vehicle).

In step S503, the IAB node 300 performs at least one of the following operations 1) to 3):
1) The IAB-MT of the IAB node 300 transmits, to the CU of the donor node (gNB 200), a message requesting RRC connection release, RRC de-configuration, or RRC reconfiguration. The message may be an RRC message, for example, a UE Assistance Information message.
2) The IAB-DU of the IAB node 300 transmits, to the CU of the donor node (gNB 200), a message requesting F1 connection release, F1 de-configuration, or F1 reconfiguration. The message may be an F1 message (F1-C message).
3) The IAB-MT or IAB-DU of the IAB node 300 transmits, to the CU of the donor node (gNB 200), a message notifying that the movement of the IAB-MT or IAB-DU of the IAB node 300 itself is detected. The message may be an RRC message or an F1 message (F1-C message).

When receiving the message of step S503, the CU of the donor node (gNB 200) may transmit, to the IAB node 300, a message (for example, RRC Reconfiguration message) for performing appropriate processing such as de-configuration of the stationary IAB configuration or changing to the mobile IAB configuration. The IAB node 300 may receive the message (step S504). The CU of the donor node (gNB 200) may perform handover to a neighboring cell (for example, a macro cell) for the UE 100 connected to the IAB node 300.

In step S505, the IAB-MT and/or the IAB-DU of the IAB node 300 stops transmission (backhaul-link transmission and/or access-link transmission) of the IAB-MT and/or the IAB-DU of the IAB node 300 itself. In the case above, in step S503, the IAB node 300 may notify the CU of the donor node (gNB 200) of the stop of transmission.

In step S505, the IAB-DU of the IAB node 300 may broadcast information for performing access restriction with information element “cellBarred” in master information block (MIB) and/or information element “cellReservedForOtherUse” or “cellReservedForFutureUse” in SIB1. This makes it possible to restrict the UE 100 in the RRC idle state or the RRC inactive state from newly reselecting a cell (mIAB cell) of the IAB node 300.

### (2.2.2) Second Operation Pattern

In the second operation pattern according to the second embodiment, the IAB node 300 configured as a mobile IAB node performs predetermined processing when detecting that the IAB node 300 itself is stationary (for example, a vehicle in which the IAB node 300 itself is installed is stationary). The predetermined processing may include transmitting, to the donor node (gNB 200), a message for preferring or requesting a change to the stationary IAB configuration. The predetermined processing may include transmitting, to the donor node (gNB 200), a message for notifying that stationariness is detected. Note that the IAB node 300 configured as a mobile IAB node may perform the predetermined processing in response to the fact that the state in which the IAB node 300 itself is stationary continues for a predetermined time.

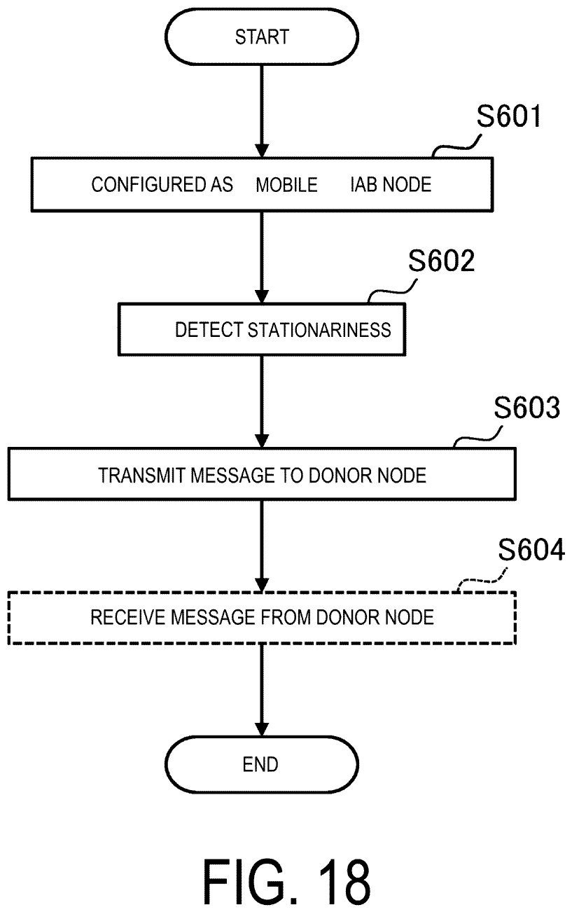

FIG. 18 is a flowchart illustrating an example of an operation of the IAB node 300 in the second operation pattern according to the second embodiment.

In step S601, the mobile IAB node 300 is configured as a mobile IAB node.

In step S602, the IAB node 300 detects that the IAB node 300 itself is stationary. For example, the IAB node 300 may detect stationariness by using the GNSS receiver of the IAB node 300 itself. The IAB node 300 may detect stationariness by receiving speed information from a vehicle (moving vehicle).

In step S603, the IAB node 300 performs at least one of the following operation 1) or operation 2).
1) The IAB-MT or IAB-DU of the IAB node 300 transmits, to the CU of the donor node (gNB 200), a message for preferring or requesting a change to the stationary IAB configuration. The message may be an RRC message, for example, a UE Assistance Information message.
2) The IAB-MT or IAB-DU of the IAB node 300 transmits, to the CU of the donor node (gNB 200), a message for notifying that the stationariness of the IAB-MT or IAB-DU of the IAB node 300 itself is detected. The message may be an RRC message or an F1 message (F1-C message).

When receiving the message of step S603, the CU of the donor node (gNB 200) may transmit, to the IAB node 300, a message (for example, RRC Reconfiguration message) for performing appropriate processing such as cancellation of the mobile IAB configuration or changing to the stationary IAB configuration. The IAB node 300 may receive the message (step S604). Here, the IAB node 300 may resume the signal transmission, which has been stopped according to the above-described movement detection. The IAB node 300 may cancel the access restriction, which has been performed according to the above-described movement detection.

### (3) Another Embodiment

In the above-described embodiment, an example in which the relay node is an IAB node has been described, but the relay node may be a network control type repeater apparatus. The repeater apparatus above is also referred to as a Network Controlled Repeater (NCR) node. The NCR apparatus, which is a relay node, includes NCR-MT and NCR-Fwd (Forwarding). The IAB-MT according to the above-described embodiment may be NCR-MT.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include a Network Controlled Repeater (NCR)-MT, and a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each processing operation performed by the UE 100, the gNB 200, or the IAB node may be provided. The program may be recorded on a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM and/or a DVD-ROM. Circuits for executing each processing operation performed by the UE 100 or the gNB 200 may be integrated, and at least a part of the UE 100, the gNB 200, and the IAB node may be implemented as a semiconductor integrated circuit (chipset, System on a chip (SoC)).

The functionality achieved by the UE 100, the gNB 200, or the mobile IAB node may be implemented in circuitry or processing circuitry including a general purpose processor and a special purpose processor that are programmed to achieve the described functions, an integrated circuit, an application specific integrated circuit (ASIC), a central processing unit (CPU), a conventional circuit, and/or combination thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### (4) First Supplementary Note

Features relating to the embodiments described above are described below as supplementary notes.

### Supplementary Note 1

A communication method performed by a relay node in a cellular communication system, the communication method including the steps of:
transmitting, to a donor node, a message including information for determining one of a mobile relay node configuration or a stationary relay node configuration as a configuration of the relay node; and
receiving, from the donor node, configuration information indicating configuration content of the relay node.

### Supplementary Note 2

The communication method according to Supplementary Note 1, in which
the relay node transmits, to the donor node, the message including a first indication indicating that the stationary relay node configuration is preferred or requested according to the stationary relay node configuration being preferred or requested.

### Supplementary Note 3

The communication method according to Supplementary Note 1 or 2, in which
the relay node transmits, to the donor node, the message including a second indication indicating that the mobile relay node configuration is preferred or requested according to the mobile relay node configuration being preferred or requested.

### Supplementary Note 4

The communication method according to any one of Supplementary Notes 1 to 3, in which
the relay node transmits, to the donor node, the message including a first indication indicating that the stationary relay node configuration is preferred or requested and a second indication indicating that the mobile relay node configuration is preferred or requested according to there being no configuration preferred or requested as the configuration of the relay node.

### Supplementary Note 5

The communication method according to any one of Supplementary Notes 1 to 4, in which
the relay node transmits, to the donor node, the message including movement information indicating a moving state of the relay node.

### Supplementary Note 6

The communication method according to Supplementary Note 5, in which
the movement information is information indicating movement speed of the relay node.

### Supplementary Note 7

The communication method according to Supplementary Note 5, in which
the movement information is information indicating possibility that the relay node moves.

### Supplementary Note 8

The communication method according to any one of Supplementary Notes 1 to 7, in which
the relay node includes a mobile termination (MT), and
the MT transmits, to the donor node, the message including the information.

### Supplementary Note 9

The communication method according to Supplementary Note 8, in which
the message is Msg5 used in a random access procedure.

### Supplementary Note 10

The communication method according to Supplementary Note 8, in which
the message is a message different from Msg5 used in a random access procedure.

### Supplementary Note 11

The communication method according to Supplementary Note 10, in which
the relay node:
starts a timer when transmitting the message; and
performing control so as not to transmit the message that follows while the timer is running.

### Supplementary Note 12

The communication method according to any one of Supplementary Notes 1 to 7, in which
the relay node includes a distributed unit (DU), and
the DU transmits, to the donor node, the message including the information.

### Supplementary Note 13

The communication method according to any one of Supplementary Notes 1 to 12, in which
the relay node includes a mobile termination (MT),
the configuration information includes information for identifying whether to configure the relay node as the mobile relay node, and
the MT receives, from the donor node, an RRC message including the configuration information.

### Supplementary Note 14

A relay node used in a cellular communication system, the relay node including:
a transmitter configured to transmit, to a donor node, a message including information for determining one of a mobile relay node configuration or a stationary relay node configuration as a configuration of the relay node; and
a receiver configured to receive, from the donor node, configuration information indicating configuration content of the relay node.

### Supplementary Note 15

A network node used as a donor node in a cellular communication system, the network node including:
a receiver configured to receive, from the relay node, a message including information for determining one of a mobile relay node configuration or a stationary relay node configuration as a configuration of the relay node; and
a transmitter configured to transmit, to the relay node, configuration information indicating configuration content of the relay node.

### Supplementary Note 16

A communication method performed by a relay node in a cellular communication system, the communication method including the steps of:
identifying, whether the relay node is configured as a mobile relay node by a network; and
controlling an operation of the relay node based on whether the relay node is configured as a mobile relay node and a moving state of the relay node.

### Supplementary Note 17

The communication method according to Supplementary Note 16, further including:
receiving, from a donor node included in the network, a radio resource control (RRC) message, in which
the RRC message includes information for specifying whether to configure the relay node as the mobile relay node, and
the relay node identifies whether the relay node is configured as the mobile relay node based on the information included in the RRC message.

### Supplementary Note 18

The communication method according to Supplementary Note 16 or 17, in which
when the relay node is configured as a stationary relay node different from the mobile relay node and movement of the relay node is detected, the controlling of the operation includes performing predetermined processing including at least one of message transmission to a donor node or stop of a relay operation.

### Supplementary Note 19

The communication method according to Supplementary Note 18, in which
the performing of the predetermined processing includes transmitting, to the donor node, a message requesting release of radio resource control (RRC) connection, cancellation of an RRC configuration, or reconfiguration of the RRC configuration between the donor node and the relay node.

### Supplementary Note 20

The communication method according to Supplementary Note 18 or 19, in which
the performing of the predetermined processing includes transmitting, to the donor node, a message for notifying the donor node of the movement.

### Supplementary Note 21

The communication method according to any one of Supplementary Notes 18 to 20, in which
the performing of the predetermined processing includes stopping at least one of signal transmission to the donor node or signal transmission to a user equipment.

### Supplementary Note 22

The communication method according to any one of Supplementary Notes 18 to 20, in which
the performing of the predetermined processing includes broadcasting information for performing access restriction of a user equipment to the relay node.

### Supplementary Note 23

The communication method according to any one of Supplementary Notes 16 to 22, in which
the relay node transmits, to a donor node, a message, when the relay node is configured as the mobile relay node and stationariness of the relay node is detected.

### Supplementary Note 24

The communication method according to Supplementary Note 23, in which
the relay node transmits, to the donor node, the message for requesting a change to a configuration of a stationary relay node different from the mobile relay node.

### Supplementary Note 25

The communication method according to Supplementary Note 23 or 24, in which
the relay node transmits, to the donor node, the message for notifying the donor node of the stationariness.

### Supplementary Note 26

A relay node used in a cellular communication system, the relay node including:
a controller configured to identify whether the relay node is configured as a mobile relay node by a network,
in which the controller controls an operation of the relay node based on whether the relay node is configured as a mobile relay node and a moving state of the relay node.

### Supplementary Note 27

A network node used as a donor node in a cellular communication system, the network node including:
a transmitter configured to transmit, to the relay node, a radio resource control (RRC) message including information for specifying whether to configure the relay node as a mobile relay node.

### (5) Second Supplementary Note

### 1. Introduction

The Rel-18 Work Item (WI) on Mobile IAB aims to support mobility of an IAB node whereas the IAB node was assumed to be stationary in Rel-16/17. In RAN2 #123-bis, the following unsolved problems were identified.
From the perspective of R2, since not supporting a child IAB node, for example, a Rel-18 mobile IAB node is not supported to operate as a Rel-16/17 IAB node simultaneously.
This means that there are limitations in the network when the simultaneous use of Rel-18 mIAB functionality and Rel-16/17 IAB functionality is configured (details need further investigation).
Whether the IAB node can transmit both Msg5 displays to the network, whether the network determines, and whether the IAB node needs to determine need further investigation.

In this supplementary note, the remaining problems of the IAB-MT access procedure will be discussed.

### 2. Discussion

### 2.1 Unsolved Problems for IAB-MT Configuration

### 2.1.1 Determination of Mobile or Stationary IAB-MT Configuration

In the above agreement, whether a network or an IAB node determines to configure an IAB-MT as the mobile IAB-MT configuration needs further investigation. It is a typical assumption that how to configure the IAB-MT depends on a network. That is, when an IAB node is stationary, a network configures the node as a Rel-16/17 stationary IAB, and otherwise, the network configures the node as a Rel-18 mobile IAB. It is comprehensible to apply the same principle to this problem.
Proposition 1: RAN2 should agree that an IAB donor decides whether to configure an IAB-MT to access as a mobile IAB-MT or a stationary IAB-MT.

On the other hand, considering that an IAB-MT to access is still in an idle mode, only the IAB-MT can know whether the IAB-MT is installed in a vehicle and whether the IAB-MT is currently/potentially moving, that is, the necessity for the mobile IAB-MT configuration. Hence, the IAB-MT needs to notify the network of the preference of the IAB-MT itself as to whether the IAB-MT itself desires to be configured in a stationary IAB node or a mobile IAB node, or it does not matter either, in some cases. The display of Msg5 can be used for notification of the preference.

It should be noted that the display above may have more meaning than “preference”. For example, it can be a “request”, especially when the IAB-MT is moving. This is because the IAB node should be configured as a mobile IAB, not a stationary IAB.
Proposition 2: RAN2 should agree that an IAB-MT transmits only a Rel-18 mobile IAB node display with Msg5 when the IAB node prefers to be configured as a mobile IAB-MT.
Proposition 3: RAN2 needs to discuss whether an IAB-MT can transmit both a Rel-18 mobile IAB node display and a conventional IAB node display with Msg5 when the IAB node does not have preference.

After an IAB donor determines to permit an IAB-MT to access to operate as a mobile IAB-MT, the IAB-MT is configured with dedicated signaling, that is, RRC reconfiguration. It is usually assumed that an IAB-MT can identify if it is configured as a mobile IAB-MT by checking whether there is a configuration unique to a mobile IAB. However, a dedicated signaling IE is completely the same between Rel-17 (stationary IAB) and Rel-18 (mobile IAB). That is, since there is no new Rel-18 IE in the RRC reconfiguration as in the ongoing CR of TS 38.331, an IAB-MT cannot know whether it is configured as a mobile IAB. Hence, a 1-bit flag needs to be introduced in the RRC reconfiguration to allow an IAB-MT to explicitly operate as a mobile IAB. For example, on the other hand, a stationary IAB node needs to operate as in the following Proposition 5.
Proposition 4: RAN2 should agree to introduce a 1-bit display in the RRC reconfiguration for notifying an IAB-MT whether it is permitted to operate as a mobile IAB node.

When an IAB donor determines to configure an IAB-MT to be accessed as a stationary IAB node, the IAB-MT may not move. However, there is a case where a train, in which an IAB node configured as a stationary IAB node is installed, starts to move. Since it is clear that a stationary IAB node cannot stop the train, it is preferable for the IAB node to, for example, stop DL transmission, report a preference/status change to the donor (for example, via UAI), be de-configured from the stationary IAB node configuration, and be reconfigured with the mobile IAB configuration. RAN2 needs to discuss what to do when a stationary IAB-MT having started moving is detected.
Proposition 5: RAN2 should discuss what to do when a stationary IAB-MT detects movement. For example, stopping transmission, displaying about movement to an IAB donor, or the like.

Note: As an alternative, mechanisms of Propositions 2 to 5 may be performed by an IAB-DU via F1-AP rather than an IAB-MT via RRC. However, the problem is identified in RAN2, and it is preferable that RAN2 make an appointment considering that it is the last meeting before Rel-18 stage 3 is settled.

### 2.2 Other Problems Related to IAB-MT Access Restriction

### 2.2.1 Access of Stationary IAB Node

It is described in WID that a mobile IAB node provides a service only to a UE. This means that a mobile IAB node may not provide a service to another IAB node as a child node.
A mobile IAB node may not have a lower IAB node. That is, a mobile IAB node provides a service only to a UE.

To ensure the requirement above, RAN2 #119e has agreed the following.
A method of not broadcasting “iab-Support (IAB support)” display is sufficient to prevent another IAB node from accessing the mobile IAB (has no influence on specification).

However, the agreement above was made without sufficient discussion. Specifically, regarding the part “(has no influence on specification)”, it is questionable that leaving it only to implementation is sufficient enough. Since it is clearly required in WID that a mobile IAB node is not permitted to access another mobile IAB node, the specification needs to make this premise clear in order to avoid confusion in a mobile IAB implementation. Hence, in a stage 2 specification, it is preferable to reflect the above-described agreement, or to clarify that “a mobile IAB node cannot access another mobile IAB node in this release”.
Proposition 6: In this release, RAN2 should agree to reflect in the Stage 2 specification that SIB does not configure IAB support IE when an IAB node operates as a mobile IAB node.

### 2.2.2 Access of Mobile IAB Node

RAN2 #120 has reached the following agreement for a mobile IAB node to access a parent node.
A mobile IAB node can camp on and connect to a conventional Rel-16/Rel-17 IAB supporting cell.
R2 assumes that a “supporting mobile-IAB (support of mobile IAB)” display is provided by a Rel-18 mobile IAB support parent cell.

Based on the agreements above, the mapping of the indication availability and the IAB node operation can be summarized in Table 1 (display in SIB and IAB node operation).

TABLE 1

| | Availability of | | | |
|---|---|---|---|---|
| | display in SIB1 | | Access restriction | |
| | iab-Support-r16 | “Support of | to IAB node | |
| | (that is, | mobile IAB” | Conventional | Mobile |
| Case | conventional IE) | (that is, new IE) | IAB node | IAB node |
| 1 | Unusable | Unusable | Barred | Barred |
| 2 | Unusable | Unusable | Barred | Permitted? |
| | | | | or Barred? |
| 3 | Unusable | Unusable | Permission | Permission |
| 4 | Unusable | Unusable | Permission | Permission |

For cases 1 and 4, since both IEs are either unusable or usable, the operation of a mobile IAB node is as in Table 1.
Proposition 7: RAN2 should agree to prohibit a mobile IAB from accessing a parent node that does not broadcast both the conventional IAB support IE and the new “Mobile IAB support” IE.
Proposition 8: RAN2 should agree to permit a mobile IAB to access a parent node that broadcasts both the conventional IAB support IE and the new “Mobile IAB support” IE.

For case 2, it is unknown whether a mobile IAB node can access a parent node when a new display is provided but no conventional IAB support IE is present. Furthermore, it needs to be discussed whether broadcasting only a new display without the conventional IE from a parent node is a valid case. Although a parent node may be deployed to serve only a mobile IAB node, it is a common case that a parent node accepts access from both a conventional IAB node and a mobile IAB node. In consideration of the possibilities above, it may be preferable to permit some flexibility in various configurations.
Proposition 9: RAN2 should discuss whether it is a valid configuration that the conventional IAB support IE is not provided and the new “Mobile IAB Node Support” IE is broadcast (that is, case 2 in Table 1).

As for the case 3, that is, in a case that the conventional IAB support IE is provided but no new display is present, since RAN2 has agreed that “a mobile IAB node can camp on and connect to a conventional Rel-16/Rel-17 IAB supporting cell”, a mobile IAB node can access a parent node. However, the expected operation of the IAB node is the same as that in the case 4. A mobile IAB node can access a parent node under a specific condition in the case 3, on the other hand, a mobile IAB node always can access a parent node in the case 4. For example, a mobile IAB node can access a parent node only when a mobile IAB node cannot find a cell that broadcasts a new display. In another example, a mobile IAB node can configure whether accessing a cell that does not broadcast a new display is permitted. For example, it may be configured by the AMF or the OAM in an authorization/verification process. Hence, RAN2 needs to clarify the conditions under which a mobile IAB node can access a parent node that does not broadcast a new display.
Proposition 10: RAN2 needs to discuss the condition that a mobile IAB node is permitted to access a parent node that broadcasts the conventional IAB support IE but does not provide the new “Mobile IAB Node Support” IE (that is, case 3 in Table 1). For example, access to a parent node is permitted only when no cell that broadcasts a new display is found.

1. A communication method performed by a relay node in a cellular communication system, the communication method comprising:
transmitting, to a donor node, an RRC Setup Complete message including one of a first indication indicating that the relay node is connected as a mobile relay node or a second indication indicating that the relay node is connected as a stationary relay node, wherein
the second indication is not included in the RRC Setup Complete message when the first indication is included in the RRC Setup Complete message, and the first indication is not included in the RRC Setup Complete message when the second indication is included in the RRC Setup Complete message.

2. The communication method according to claim 1, wherein
the RRC Setup Complete message is Msg5 used in a random access procedure.

3. A relay node in a cellular communication system, the relay node comprising a transceiver circuitry and a processing circuitry operatively associated with the transceiver circuitry and configured to execute processing of:
transmitting, to a donor node, an RRC Setup Complete message including one of a first indication indicating that the relay node is connected as a mobile relay node or a second indication indicating that the relay node is connected as a stationary relay node, wherein
the second indication is not included in the RRC Setup Complete message when the first indication is included in the RRC Setup Complete message, and the first indication is not included in the RRC Setup Complete message when the second indication is included in the RRC Setup Complete message.

4. A cellular communication system comprising a relay node and a donor node, wherein
the relay node is configured to transmit, to a donor node, an RRC Setup Complete message including one of a first indication indicating that the relay node is connected as a mobile relay node or a second indication indicating that the relay node is connected as a stationary relay node, and
the second indication is not included in the RRC Setup Complete message when the first indication is included in the RRC Setup Complete message, and the first indication is not included in the RRC Setup Complete message when the second indication is included in the RRC Setup Complete message.

5. A non-transitory computer-readable medium storing instructions that, when executed by a processor of a relay node, cause the processor to carry out the method according to claim 1.

6. A chipset for a relay node in a cellular communication system, the chipset configured to execute the instructions stored on the non-transitory computer-readable medium of claim 5.
